(19) United States
(12) Patent Application Publication
(10) Pub. No.: US 2026/0347720 A1
(43) Pub. Date: Nov. 5, 2026

(54) A GRAPHENE-BASED LUBRICANT FOR AUTOMOTIVE AND A METHOD OF PREPARING THE SAME

(71) Applicant: NANOMALAYSIA BERHAD, Kuala Lumpur (MY)

(72) Inventors: MOHAMMAD KHALID, Selangor (MY); ABDUL KHALIQ RASHEED, Selangor (MY); NURUL IZYAN SUPIANDI, Kuala Lumpur (MY)

(21) Appl. No.: 19/124,738

(22) PCT Filed: Nov. 25, 2022
(86) PCT No.: PCT/MY2022/050119

§ 371 Date: Apr. 25, 2025

(30) Foreign Application Priority Data
Oct. 27, 2022 (MY) PI2022006015

(51) Int. Cl. C10M 125/02; C01B 32/194; C01B 32/198; C10N 40/25

(52) U.S. Cl. CPC C10M 125/02; C01B 32/194; C01B 32/198; C10M 2201/14; C10N 2040/25

(57) ABSTRACT

The present invention relates to a graphene-based lubricant for automotive, comprising a base oil and an amine functionalized graphene oxide, characterized by: the amine functionalized graphene oxide is selected from heptylamine, hexadecylamine, tetradecylamine, octadecylamine, or a combination thereof; wherein the concentration of amine functionalized graphene oxide is 0.005 to 0.05 wt %. Further, a method of preparing an amine functionalized graphene oxide is disclosed therein.

### TECHNICAL FIELD

The present invention relates to a graphene-based lubricant, more particularly, a method of preparing graphene-based lubricant for automotive.

### BACKGROUND ART

An efficient lubricant is demanded to protect mechanical components from friction and wear in aerospace, automotive, military, and various industrial applications. The addition of nanomaterials such as but not limited to graphene as additives in base lubricant oil is a rapidly progressing field of research because nanomaterials are different from traditional bulk materials due to their extremely small size and high specific surface area. However, the use of graphene as an oil additive at higher temperatures is a failure as it damages the protective film formed by the graphene and a significant increase in agglomerations within the lubricant.

There have been several solutions provided for a graphene-based lubricant and a method of preparing the same, and a few of them have been discussed below:

CN106350153A discloses a graphene oxide modifying method and application in engine lubricating oil. The method comprises preparing graphene oxide (GO) by adopting an improved Hummers process, modifying the graphene oxide with long-chain fatty amine and organic silicon to obtain a modified graphene derivative. Further, the modified graphene oxide is used as A) a friction modifier with a metal cleaning agent; B) a metal corrosion inhibitor; C) a complex antioxidant, an anti-foaming agent, a viscosity index improver, synthetic ester base oil, and base oil so that the engine lubricating oil added with the graphene oxide modifying agent.

T Gayatri Paul, et. al., 2019, “Tribological behavior of dodecylamine functionalized graphene nanosheets dispersed engine oil nanolubricants’, discloses a study that investigates the tribological properties of nanolubricants dispersed with dodecylamine functionalized graphene (DAG) in commercial engine oil. Standard techniques were used to determine the morphology of the DAG and the worn surfaces. The tribological properties of the nanolubricants were measured using a UMT-2 tribotester with an in-house attachment developed for measuring the friction of liquid lubricants. The nanolubricants were observed to reduce the coefficient of friction (COF) by a maximum ~40% in comparison to base engine oil. Parameters including the concentration, load, and sliding velocity were found to influence the variation of COF considerably. Characterization of the wear tracks by EDX and XPS suggests the formation of a tribo-film as the plausible mechanism which lowers the COF in the case of the nanolubricants.

Accordingly, it can be seen in the prior arts that there exists a need to have an improved method of preparing graphene-based lubricant which able to achieve better wear scare diameter reduction, higher oxidation stability and improved thermal conductivity.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

An objective of the present invention is to provide a graphene-based lubricant with long-term stability against high temperature and shear.

Accordingly, the objective may be achieved by following the teachings of the present invention. The present invention relates to a graphene-based lubricant for automotive, comprising a base oil and an amine functionalized graphene oxide, characterized by: the amine functionalized graphene oxide is selected from heptylamine, hexadecylamine, tetradecylamine, octadecylamine, or a combination thereof; wherein the concentration of amine functionalized graphene oxide is 0.005 to 0.05wt %.

The present invention relates to a method of preparing an amine functionalized graphene oxide comprising the steps of: preparing graphene oxide from graphite powder via a modified hummers method and functionalizing the graphene oxide with amine via amidation reaction and chemical reduction, characterized in that: the amine is selected from heptylamine, hexadecylamine, tetradecylamine, octadecylamine, or a combination thereof; wherein the concentration of amine functionalized graphene oxide is 0.005 to 0.05wt %.

### BRIEF DESCRIPTION OF THE ACCOMPANYING DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawing illustrates only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 is a graph showing a wear scar diameter of semi-synthetic 10W-40 nanolubricant formulation in different percentage of graphene additive prepared in accordance with an embodiment of the present invention;

FIG. 2 is a graph showing oxidation induction time of semi-synthetic 10W-40 nanolubricant formulation in different percentage of graphene additive prepared in accordance with an embodiment of the present invention; and

FIG. 3 is a graph showing thermal conductivity enhancement of semi-synthetic 10W-40 nanolubricant formulation prepared in accordance with an embodiment of the present invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for claims. It should be understood that the drawings and detailed description thereto are not intended to limit the invention to the particular form disclosed, but on the contrary, the invention is to cover all modifications, equivalents and alternatives falling within the scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned. Where the abbreviations or technical terms are used, these indicate the commonly accepted meanings as known in the technical field.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary and are not intended to limit the scope of the invention.

With reference to the drawings, the invention will now be described in more detail.

The present invention relates to a graphene-based lubricant for automotive, comprising a base oil and an amine functionalized graphene oxide, characterized by: the amine functionalized graphene oxide is selected from heptylamine, hexadecylamine, tetradecylamine, octadecylamine, or a combination thereof; wherein the concentration of amine functionalized graphene oxide is 0.005 to 0.05wt %.

In accordance with an embodiment of the present invention, the amine for functionalized graphene oxide is preferably octadecylamine. The octadecylamine which is a primary alkyl amine mainly used as a hydrophobic surface modifier and a compound with a longer carbon chain which provides better results.

The present invention also relates to a method of preparing an amine functionalized graphene oxide comprising the steps of: preparing graphene oxide from graphite powder via a modified hummers method and functionalizing the graphene oxide with amine via amidation reaction and chemical reduction, characterized in that: the amine is selected from heptylamine, hexadecylamine, tetradecylamine, octadecylamine, or a combination thereof; wherein the concentration of amine functionalized graphene oxide is 0.005 to 0.05wt %.

The present invention further discloses a method of preparing graphene oxide from graphite powder via modified hummers method, characterized by the steps of: mixing inorganic acid and stirring for 10minutes, adding graphite powder in the mixture and stirring the mixture, adding inorganic compound in the mixture and stirring for 48hours, diluting the mixture with hydrogen peroxide and stirring for 30minutes to eliminate the excess inorganic compound, cooling down the mixture after an exothermic reaction, washing the mixture with hydrochloric acid and deionized water, centrifuging the solution at 7000rpm for 10 minutes; decanting the supernatants and washing the residuals with hydrochloric acid and deionized water for at least 4 times, and drying the residuals at 40 °C for 48 hours to produce the powder of graphene oxide.

In accordance with an embodiment of the present invention, the inorganic acid is selected from sulfuric acid, phosphoric acid, or a combination thereof.

In accordance with an embodiment of the present invention, the inorganic compound is selected from potassium permanganate.

The present invention further discloses a method of functionalizing the graphene oxide with amine via amidation reaction and chemical reduction, comprising the steps of: dispersing graphene oxide powder in deionized water, dispersing amine in ethanol, mixing both solutions and stirring at 20 to 60 °C for 48hours, decanting the residual and drying the residual using an oven at 70 °C for 24hours to produce the amine functionalized graphene oxide powder.

Hereinafter, examples of the present invention will be provided for more detailed explanation. It will be understood that the examples described below are not intended to limit the scope of the present invention.

### EXAMPLES

### Preparation of Graphene Oxide by a Modified Hummer's Method

Graphene Oxide (GO) was produced using the modified hummers method from pure graphite powder. In this method, 360 ml of sulfuric acid (H₂SO₄) and 40 ml of phosphoric acid (H₃PO₄) (volume ratio 9:1) were mixed and stirred for 10 minutes. Then 2.025 g of graphite powder was added to the mixing solution under stirring conditions. 11.88 g of potassium permanganate (KMnO₄) was then added slowly into the solution. This mixture was stirred for 48 hours until the solution became dark green. To eliminate the excess of KMnO₄, 6.075 ml of hydrogen peroxide (H₂O₂) was dropped slowly and stirred for 30 minutes. The exothermic reaction occurred and let it cool down. 90 ml of hydrochloric acid (HCl) and 270 ml of deionized water were added and centrifuged at 7000 rpm for 10 minutes. Then, the supernatant was decanted away and the residuals were then rewashed again with HCL and DL water 4 times. The washed GO solution was dried using the oven at 40 °C for 48 hours to produce the powder of GO.

### Preparation of Functionalized Graphene Oxide (go)

For the functionalization 5 gm of GO was dispersed in 1250 ml of DL water. Then 12.5 g of octadecylamine was dispersed in 3750 ml of ethanol. After that the both solution is mixed together and stirred for 48 hours. The functionalized GO will float on top of the solution after 48 hours as its became hydrophobic in nature. The residual was decanted and dried in oven for 70 °C for 24 hours to produce the functionalized GO powder.

### Results and Discussions

All lubricant testing were performed according to their respective ASTM standards.

### Wear Scar Diameter [four Ball Wear (astm D-4172)]

ASTM D 4172 standard methods are followed for the tribological investigations using 4-ball tribometer. The test conditions for ASTM D 4172 include temperature 75 °C ±1.7 °C, speed 1200±50rpm, load 40 +0.2 kg and test duration of 60±min. The steel balls surface is analyzed using microscope. The four ball wear test determines the wear and friction protection properties of a lubricant. Three metal balls are clamped together and covered with the test lubricant, while a rotating fourth ball is pressed against them in sliding contact. This contact typically produces a wear scar, which is measured and recorded. The smaller the average wear scar diameter, the better the wear and friction protection provided by the lubricant.

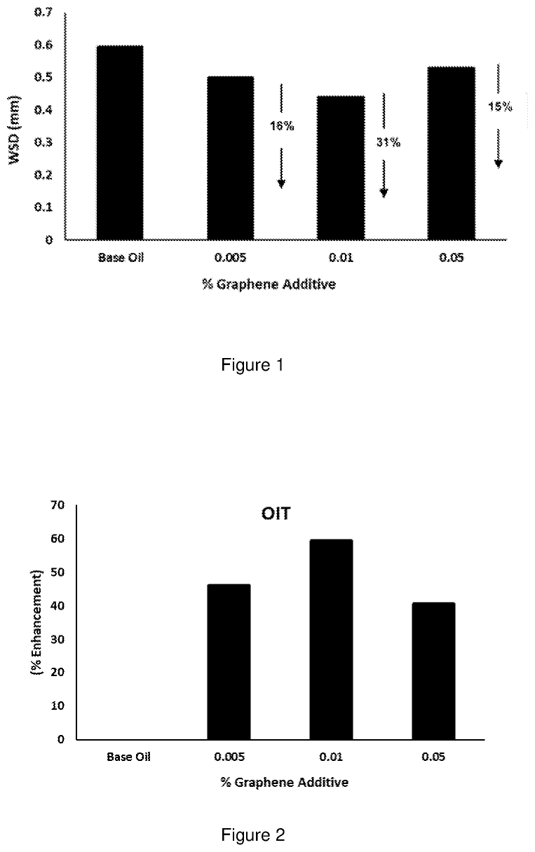

As shown in FIG. 1, semi-synthetic 10W-40 nanolubricant formulation with 0.01 wt % of modified graphene produced the smallest wear scar, almost 31 percent smaller than the base oil formulation. This clearly shows that the modified graphene forms a protective boundary over the steel balls that helps in reducing the friction during high speed rotation. Lower friction and wear will boost both the engine life and performance.

### Oxidative Induction Time (OIT)

Oxidation induction time (OIT) is defined as the time to the onset of oxidation of oil samples exposed to an oxidizing gas at elevated pressure and isothermal test temperature. The test conditions for this analysis were maintained at 500 psi and 200 °C As shown in FIG. 2, semi-synthetic formulation with all graphene concentration shows improved stability. However, at 0.01 wt % shows a remarkable increase by 59% in oxidation stability. The results indicate the ability of graphene to enhance the anti-oxidation properties allowing engine oil to effectively resist the formation of engine deposits and sludge, keeping engines running clean and efficient and extending oil life. It also resists thickening, maintaining its superior wear protection and lubricating properties and maximizing fuel efficiency.

### Thermal Conductivity

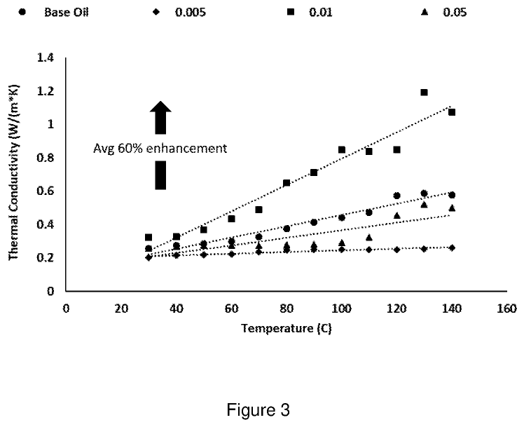

Thermal conductivity (TC) is a measure of the ability of a material to transfer heat, higher the TC more efficient will be the heat transfer. FIG. 3 shows the TC of semi-synthetic 10W-40 oils. It is clear that the TC is a strong function of graphene concentration and also the size. Semi-synthetic 10W40 with 0.01 wt % graphene gave the highest TC enhancement of 60 percent.

All the above results indicate graphene with few layers helps in enhancing the overall lubricant performance.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A graphene-based lubricant for automotive, comprising:
a base oil; and
an amine functionalized graphene oxide;
characterized by:
the amine functionalized graphene oxide is selected from heptylamine, hexadecylamine, tetradecylamine, octadecylamine, or a combination thereof;
wherein the concentration of amine functionalized graphene oxide is 0.005 to 0.05 wt %.

2. A method of preparing an amine functionalized graphene, comprising the steps of:
preparing graphene oxide from graphite powder via a modified hummers method; and
functionalizing the graphene oxide with amine via amidation reaction and chemical reduction;
characterized in that:
the amine is selected from heptylamine, hexadecylamine, tetradecylamine, octadecylamine, or a combination thereof;
wherein the concentration of amine functionalized graphene oxide is 0.005 to 0.05 wt %.

3. A method for preparing graphene oxide from graphite powder via the modified hummers method as claimed in claim 2 characterized by the steps of:
mixing inorganic acid and stirring for 10 minutes;
adding graphite powder in the mixture and stirring the mixture;
adding inorganic compound in the solution and stirring for 48 hours;
diluting the mixture with hydrogen peroxide and stirring for 30 minutes to eliminate the excess inorganic compound;
cooling down the mixture after an exothermic reaction;
washing the mixture with hydrochloric acid and deionized water;
centrifuging the mixture at 7000 rpm for 10 minutes;
decanting the supernatants and washing the residuals with hydrochloric acid and deionized water for at least 4 times; and
drying the residuals at 40 °C for 48 hours to produce the powder of graphene oxide.

4. The method as claimed in claim 3, wherein the inorganic acid is selected from sulfuric acid, phosphoric acid, or a combination thereof.

5. The method as claimed in claim 3, wherein the inorganic compound is selected from potassium permanganate.

6. The method as claimed in claim 2, wherein the step of functionalizing the graphene oxide with amine via amidation reaction and chemical reduction comprising the steps of:
dispersing graphene oxide powder in deionized water;
dispersing amine in ethanol;
mixing both solutions and stirring at 20 to 60 °C for 48 hours;
decanting the residual and drying the residual using an oven at 70 °C for 24 hours to produce the amine functionalized graphene oxide powder.
